(19) United States
(12) Patent Application Publication
(10) Pub. No.: US 2012/0032620 A1
(43) Pub. Date: Feb. 9, 2012

(54) CONTROL DEVICE

(75) Inventors: Arinori SHIMADA, Nishio (JP); Subrata SAHA, Anjo (JP); Ken IWATSUKI, Anjo (JP)

(73) Assignee: AISIN AW CO., LTD., Anjo-shi (JP)

(21) Appl. No.: 13/170,722

(22) Filed: Jun. 28, 2011

(30) Foreign Application Priority Data
Aug. 5, 2010 (JP) 2010-176680

(51) Int. Cl. H02P 1/04

(52) U.S. Cl. 318/400.09

(57) ABSTRACT

A control device that controls for an electric motor drive device including a DC/AC conversion section that converts a DC voltage into an AC voltage to supply the AC voltage to an AC electric motor. The control device is configured with a computation cycle setting section that sets a computation cycle of the control signal generation section to a first cycle, which is N times (N is an integer of 1 or more) a reference computation cycle that is set to half a carrier cycle, and that sets a computation cycle of the voltage command value determination section to a second cycle, which is M times (M is an integer of 2 or more) the first cycle, in the case where the control mode determined by the control mode determination section is the pulse width modulation control mode.

### INCORPORATION BY REFERENCE

The disclosure of Japanese Patent Application No. 2010-176680 filed on Aug. 5, 2010 including the specification, drawings and abstract is incorporated herein by reference in its entirety.

### BACKGROUND OF THE INVENTION

The present invention relates to a control device that controls an electric motor drive device including a DC/AC conversion section that converts a DC voltage into an AC voltage to supply the AC voltage to an AC electric motor.

### DESCRIPTION OF THE RELATED ART

An example of the above control device according to the related art is described in Japanese Patent No. 3890907 below, for example. In the control device disclosed in Japanese Patent No. 3890907, in order to generate a control signal for the DC/AC conversion section matching a voltage command value on the basis of pulse width modulation (PWM) control, current feedback computation is performed on the basis of the deviation between a detected value and a command value of a current flowing through a coil to generate the voltage command value. In order to enable even a computation device with low processing power to control a plurality of AC electric motors, the control device is configured to set an interrupt cycle to one cycle of a PWM carrier, set the cycle of the current feedback computation for each of the AC electric motors to twice or an integer n times the interrupt cycle, and execute current feedback computations for different AC electric motors in interrupt cycles that are different from each other. This makes it possible to temporally distribute the timings to execute the current feedback computations which require a high processing load so that even a computation device with low processing power can successfully handle the computations.

The AC electric motor can be controlled by controlling the DC/AC conversion section also through rectangular-wave control, besides the PWM control, in terms of the waveform of an output voltage of the DC/AC conversion section. The rectangular-wave control makes it possible to enhance the voltage utilization rate (modulation rate) of a DC power source compared to that in the PWM control, and therefore to cause the AC electric motor to generate a higher torque. Because the rectangular-wave control is significantly different from the PWM control in control scheme, the processing load may not be reduced during execution of the rectangular-wave control by applying a technique that is the same as that for the PWM control as it is. However, Japanese Patent No. 3890907 includes no description of the rectangular-wave control, and there has yet been revealed no configuration that can appropriately reduce the processing load during execution of the rectangular-wave control.

### SUMMARY OF THE INVENTION

In view of the foregoing, it is desirable to provide a control device that can execute control based on the rectangular-wave control in addition to control based on the PWM control and that can appropriately reduce the processing load during execution of the control based on the rectangular-wave control.

According to a first aspect of the present invention, a control device that controls an electric motor drive device including a DC/AC conversion section that converts a DC voltage into an AC voltage to supply the AC voltage to an AC electric motor, includes: a control mode determination section that determines execution of one of a plurality of control modes including a pulse width modulation control mode and a rectangular-wave control mode; a voltage command value determination section that determines an AC waveform command value, which is a command value of a waveform of the AC voltage supplied from the DC/AC conversion section to the AC electric motor, as a voltage command value in the case where the control mode determined by the control mode determination section is the pulse width modulation control mode, and that determines a phase value of a rectangular-wave voltage as the voltage command value in the case where the control mode determined by the control mode determination section is the rectangular-wave control mode; a control signal generation section that generates a control signal for the DC/AC conversion section on the basis of the control mode determined by the control mode determination section and the voltage command value; and a computation cycle setting section that sets a computation cycle of the control signal generation section to a first cycle, which is N times (N is an integer of 1 or more) a reference computation cycle that is set to half a carrier cycle, and that sets a computation cycle of the voltage command value determination section to a second cycle, which is M times (M is an integer of 2 or more) the first cycle, in the case where the control mode determined by the control mode determination section is the pulse width modulation control mode. In the control device, the computation cycle setting section sets both the computation cycle of the voltage command value determination section and the computation cycle of the control signal generation section to the second cycle in the case where the control mode determined by the control mode determination section is the rectangular-wave control mode.

According to the first aspect, the processing load can be reduced appropriately while maintaining good control characteristics during execution of the rectangular-wave control mode on the basis of the difference in control scheme between the pulse width modulation control mode and the rectangular-wave control mode.

That is, while the pulse width modulation control mode provides a larger number of timings to allow changes of the control signal to be reflected per one cycle of the electrical angle, the rectangular-wave control mode provides a smaller number of timings to allow changes of the control signal to be reflected per one cycle of the electrical angle. Therefore, during execution of the rectangular-wave control mode, the computation cycle of the control signal generation section, which executes a process for generating the control signal, may be made to be longer than that during execution of the pulse width modulation control mode while maintaining good control characteristics. In the present invention, with a focus on such characteristics peculiar to the rectangular-wave control mode, the computation cycle of the control signal generation section, which is set to the first cycle during execution of the pulse width modulation control mode, is set to the second cycle, which is M times the first cycle, during execution of the rectangular-wave control mode. Consequently, the processing load can be reduced by an amount by which the control signal generation process performed by the control signal generation section is partially omitted, compared to a case where the computation cycle of the control signal generation section is set to the first cycle also during execution of the rectangular-wave control mode as during execution of the pulse width modulation control mode.

According to the above first aspect, in addition, the computation cycle of the voltage command value determination section, which executes a voltage command value determination process which tends to require a high computation load, is set to the second cycle, which is M times the first cycle, both during execution of the pulse width modulation control mode and during execution of the rectangular-wave control mode. Therefore, the processing load can also be reduced by an amount by which the voltage command value determination process is partially omitted, compared to a case where ₜhe computation cycle of the voltage command value determination section is set to the first cycle.

A carrier that defines the carrier cycle according to the present invention may be the same as a carrier of a pulse width modulation waveform during execution of the pulse width modulation control mode. In this case, “N” may be “1”, for example. Alternatively, the carrier that defines the carrier cycle according to the present invention may be different from the carrier of the pulse width modulation waveform. In this case, “N” may be a ratio of the cycle of the carrier of the pulse width modulation waveform to the carrier cycle according to the present invention, for example.

According to a second aspect of the present invention, the control device may further include a torque deviation derivation section that derives a deviation between an output torque and a target torque of the AC electric motor, the voltage command value determination section may perform at least proportional control and integral control on the basis of the deviation derived by the torque deviation derivation section to determine the phase value of the rectangular-wave voltage in the case where the control mode determined by the control mode determination section is the rectangular-wave control mode, and the computation cycle setting section may set a computation cycle of the torque deviation derivation section to a third cycle, which is L times (L is an integer of 2 or more) the second cycle, in the case where the control mode determined by the control mode determination section is the rectangular-wave control mode.

According to the second aspect, the processing load can be further reduced while maintaining good control characteristics in the case where variations in output torque and target torque, which are used in a torque deviation derivation process performed by the torque deviation derivation section, within a period that corresponds to the second cycle are so slow.

According to a third aspect of the present invention, in the above configuration in which the computation cycle of the torque deviation derivation section is set to the third cycle in the case where the control mode determined by the control mode determination section is the rectangular-wave control mode, the control device may further include an estimated torque value derivation section that derives an estimated torque value, which is an estimated value of the output torque, on the basis of a detected value of a current flowing through a coil of the AC electric motor, the torque deviation derivation section may derive the deviation using the estimated torque value as the output torque, and the computation cycle setting section may set a computation cycle of the estimated torque value derivation section to the third cycle in the case where the control mode determined by the control mode determination section is the rectangular-wave control mode.

According to the third aspect, the computation cycle of the estimated torque value derivation section is set to the third cycle, as with the computation cycle of the torque deviation derivation section. Therefore, the processing load can be further reduced by suppressing derivations of the estimated torque value in unnecessarily short cycles. In addition, the capability of the torque deviation derived by the torque deviation derivation section to follow variations in output torque can be maintained at a high level.

According to a fourth aspect of the present invention, computation processes for determining the voltage command value through the voltage command value determination sections for the AC electric motors in the number M may be performed by a single computation processing unit, and computations through the voltage command value determination sections for the respective M AC electric motors may be performed in the second cycles and in the reference computation cycles that are different from each other.

According to the fourth aspect, computations through the voltage command value determination sections for the M AC electric motors, which tend to require a high computation load, are executed in the reference computation cycles that are different from each other. Therefore, the M AC electric motors can be controlled appropriately using a computation processing unit with limited processing power.

### BRIEF DESCRIPTION OF THE DRAWINGS

FIG. 1 is a functional block diagram of a control device according to a first embodiment of the present invention;

FIG. 2 is a circuit diagram showing the configuration of an electric motor drive device according to the first embodiment of the present invention;

FIG. 3 shows an example of three-phase voltage command values in a rectangular-wave control mode according to the first embodiment of the present invention;

FIG. 4 shows an example of a control mode map according to the first embodiment of the present invention;

FIG. 5 is a time chart showing the timing to execute each process in a PWM control mode according to the first embodiment of the present invention;

FIG. 6 is a time chart showing the timing to execute each process in the rectangular-wave control mode according to the first embodiment of the present invention;

FIG. 7 is a flowchart showing the process procedures of an electric motor control process according to the first embodiment of the present invention;

FIG. 8 is a time chart showing the timing to execute each process according to a second embodiment of the present invention; and

FIG. 9 is a time chart showing the timing to execute each process according to the second embodiment of the present invention.

### DETAILED DESCRIPTION OF THE EMBODIMENTS

### 1. First Embodiment

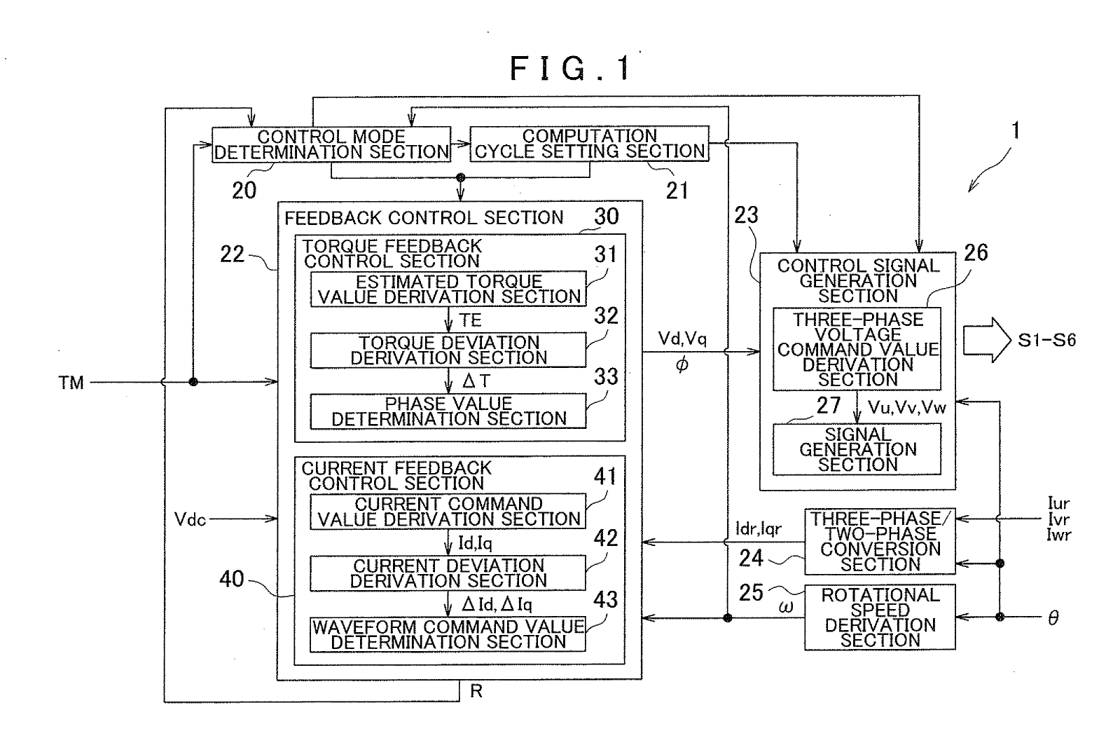

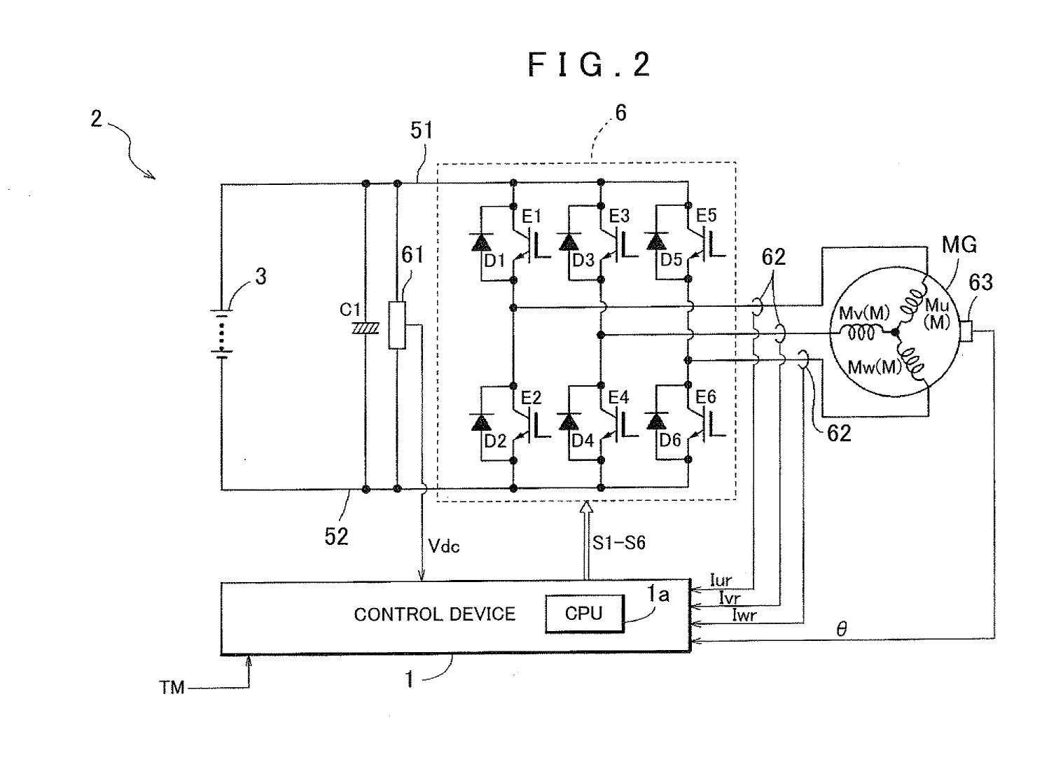

A control device according to an embodiment of the present invention will be described with reference to the drawings. As shown in FIGS. 1 and 2, a control device 1 according to the embodiment includes a control mode determination section 20 that determines the control mode, a voltage command value determination section (a phase value determination section 33 and a waveform command value determination section 43 to be described later) that determines a voltage command value, a control signal generation section 23 that generates switching control signals S1 to S6 for an inverter 6 on the basis of the control mode and the voltage command value, and a computation cycle setting section 21 that sets the computation cycle of the voltage command value determination section and the computation cycle of the control signal generation section 23. The control device 1 is configured to control an electric motor drive device 2 including the inverter 6 which converts a DC voltage Vdc into an AC voltage to supply the AC voltage to an electric motor MG. In the embodiment, the electric motor MG is an interior permanent magnet synchronous motor (IPMSM) that operates on three-phase AC.

In such a configuration, the control device 1 according to the embodiment is characterized in how the computation cycle setting section 21 sets the computation cycle of the voltage command value determination section and the computation cycle of the control signal generation section 23 on the basis of the control mode. The configuration of the control device 1 according to the embodiment will be described in detail below. In the embodiment, the electric motor MG, the inverter 6, and the switching control signals S1 to S6 correspond to the “AC electric motor”, the “DC/AC conversion section”, and the “control signal”, respectively, according to the present invention. In the embodiment, in addition, the phase value determination section 33 and the waveform command value determination section 43 form the “voltage command value determination section” according to the present invention.

### 1-1. Overall Configuration of Control Device

First, the overall configuration of the control device 1 according to the embodiment will be described with reference to FIGS. 1 and 2. As shown in FIG. 1, the control device 1 includes the control mode determination section 20, the computation cycle setting section 21, a feedback control section 22, the control signal generation section 23, a three-phase/two-phase conversion section 24, and a rotational speed derivation section 25. The control device 1 receives as inputs a target torque TM, detected values (a U-phase current Iur, a V-phase current Ivr, and a W-phase current Iwr) of currents flowing through coils M of the electric motor MG, and a magnetic pole position θ of a rotor of the electric motor MG. The respective functional sections of the control device 1 described above execute a process for controlling the electric motor drive device 2 on the basis of the input values. In the embodiment, the respective functional sections of the control device 1 are formed by an electric motor control program stored in a memory (program memory) of a CPU 1a. The CPU 1a (to be more exact, a CPU core of the CPU 1a) operates as a computer that executes the electric motor control program. In the embodiment, the CPU 1a of the control device 1 is a single-task microcomputer. In the embodiment, the CPU 1a corresponds to the “computation processing unit” according to the present invention.

The rotational speed derivation section 25 is a functional section that derives a rotational speed ω of the electric motor MG on the basis of the magnetic pole position θ (the rotational angle of the rotor in the electrical angle). As shown in FIG. 2, the magnetic pole position θ of the rotor of the electric motor MG at each time point is detected by a rotation sensor 63 and input to the control device 1 (in the embodiment, the rotational speed derivation section 25, the three-phase/two-phase conversion section 24, and the control signal generation section 23). Then, the rotational speed ω derived by the rotational speed derivation section 25 is output to the control mode determination section 20 and the feedback control section 22. The rotation sensor 63 is formed by a resolver or the like, for example.

The three-phase/two-phase conversion section 24 is a functional section that performs three-phase/two-phase conversion on the detected values Iur, Ivr, and Iwr of the input currents for the respective phases on the basis of the magnetic pole position θ to derive an actual d-axis current Idr and an actual q-axis current Iqr. The d-axis is set to extend in the direction of magnetic flux of the field, and the q-axis is set to extend in a direction advanced with respect to the direction of the field by an electrical angle of π/2. Detected values (the actual d-axis current Idr and the actual q-axis current Iqr) of the currents in the d-q coordinate system derived by the three-phase/two-phase conversion section 24 are output to the feedback control section 22. As shown in FIG. 2, the detected current values Iur, Ivr, and Iwr for the respective phases are obtained by current sensors 62 and input to the control device 1. In the embodiment, the currents for all the three phases are detected. The three phases, namely u-phase, v-phase, and w-phase, are balanced, and the instantaneous value of the sum of the currents for the three phases is zero. Therefore, it is also possible to detect the currents for only two of the three phases and obtain the current for the remaining phase through computation performed by the control device 1 (the CPU 1a).

The feedback control section 22 is a functional section that derives the voltage command value, which is utilized by the control signal generation section 23 to generate the switching control signals S1 to S6, on the basis of the target torque TM, the actual d-axis current Idr, the actual q-axis current Iqr, and the rotational speed ω. The target torque TM of the electric motor MG is input to the control device 1 (in the embodiment, the control mode determination section 20 and the feedback control section 22) as a signal representing a request from another control device or the like (not shown). That is, the target torque TM is a command value (torque command value) for an output torque of the electric motor MG. For example, in the case where the control device 1 is a control device for the electric motor drive device 2 which controls the electric motor MG used as a drive power source for an electric vehicle, a hybrid vehicle, or the like, the target torque TM is determined in accordance with an operation of an accelerator performed by a driver of the vehicle or the like. Then, the voltage command value derived by the feedback control section 22 is output to the control signal generation section 23. As described later, the feedback control section 22 is configured to derive the voltage command value (a phase value φ) by causing a torque feedback control section 30 to function in a rectangular-wave control mode, and to derive the voltage command value (AC waveform command values Vd and Vq) by causing a current feedback control section 40 to function in a pulse width modulation (hereinafter referred to as “PWM”) control mode. That is, in the embodiment, the content of a feedback control process executed by the feedback control section 22 is different between the control modes. The configurations of the torque feedback control section 30 and the current feedback control section 40 will be described in detail later in Section 1-2 and Section 1-3, respectively.

The feedback control section 22 is also configured to derive a modulation rate R, which is the ratio of the effective value of a fundamental-wave component of an output voltage waveform of the inverter 6 to the DC voltage Vdc, as described in detail later. As shown in FIG. 2, the DC voltage Vdc is the voltage of a DC power source 3, and is detected by a voltage sensor 61 and input to the control device 1. The DC power source 3 is formed by various types of secondary batteries such as nickel-hydrogen secondary batteries and lithium-ion secondary batteries, capacitors, or a combination thereof, for example. In the embodiment, a smoothing condenser C1 that smoothes the DC voltage Vdc from the DC power source 3 is provided.

The control signal generation section 23 is a functional section that generates the switching control signals S1 to S6 for driving the inverter 6 on the basis of the control mode determined by the control mode determination section 20, the voltage command value derived by the feedback control section 22, and the magnetic pole position θ detected by the rotation sensor 63. The control signal generation section 23 generates AC voltage command values for the three phases (a U-phase voltage command value Vu, a V-phase voltage command value Vv, and a W-phase voltage command value Vw) on the basis of the voltage command value derived by the feedback control section 22 to generate the switching control signals S1 to S6 on the basis of the AC voltage command values Vu, Vv, and Vw. Then, drive control of the electric motor MG is performed via the inverter 6 in accordance with the switching control signals S1 to S6 generated by the control signal generation section 23. The configuration of the control signal generation section 23 will be described in detail later in Section 1-4.

The inverter 6 is a device that converts the DC voltage Vdc into an AC voltage to supply the AC voltage to the electric motor MG In the embodiment, the inverter 6 is configured to include a plurality of sets of switching elements and a plurality of diodes that function as free-wheel diodes. Specifically, the inverter 6 includes a pair of switching elements for each of the respective phases (the three phases, namely U-phase, V-phase, and W-phase) of the electric motor MG, which are specifically a U-phase upper arm element E1 and a U-phase lower arm element E2, a V-phase upper arm element E3 and a V-phase lower arm element E4, and a W-phase upper arm element E5 and a W-phase lower arm element E6. A corresponding one of the diodes D1 to D6 is connected in series with each of the switching elements E1 to E6. Power transistors of various structures such as an IGBT (insulated gate bipolar transistor) type, a bipolar type, a field-effect type, and a MOS type may be used as the switching elements E1 to

E6.

The emitters of the upper arm elements E1, E3, and E5 for each phase and the collectors of the lower arm elements E2, E4, and E6 for each phase are respectively connected to the coils M (a U-phase coil Mu, a V-phase coil Mv, and a W-phase coil Mw) of the electric motor MG for each phase. The collectors of the upper arm elements E1, E3, and E5 for each phase are connected to a system voltage line 51. The emitters of the lower arm elements E2, E4, and E6 for each phase are connected to a negative electrode line 52.

The switching elements E1 to E6 are respectively turned (switched) on and off in accordance with the switching control signals S1 to S6 output from the control signal generation section 23. Consequently, the inverter 6 converts the DC voltage Vdc into an AC voltage to supply the AC voltage to the electric motor MG, which causes the electric motor MG to output a torque matching the target torque TM. In the embodiment, each of the switching control signals S1 to S6 is a gate drive signal for driving the gate of each of the switching elements E1 to E6.

In the embodiment, the electric motor MG is configured to operate also as a generator as necessary. When the electric motor MG functions as a generator, the inverter 6 converts a generated AC voltage into a DC voltage to supply the DC voltage to the system voltage line 51.

The control mode determination section 20 is a functional section that determines the control mode of the electric motor drive device 2 (electric motor MG) on the basis of the target torque TM and the rotational speed co derived by the rotational speed derivation section 25. The control mode determination section 20 is configured to determine execution of one of a plurality of control modes including the PWM control mode and the rectangular-wave control mode. In the embodiment, the control mode determination section 20 is configured to select one of the PWM control mode and the rectangular-wave control mode to determine execution of the selected control mode.

In the PWM control mode, the duty ratio of each pulse is controlled such that a PWM waveform, which is the output voltage waveform of the inverter 6 for each of the U-, V-, and W-phases, is formed by a collection of pulses forming high-level periods for which the upper arm elements E1, E3, and E5 are turned on and low-level periods for which the lower arm elements E2, E4, and E6 are turned on, and such that the fundamental-wave component of the PWM waveform forms a generally sinusoidal wave in a certain period. In the PWM control, the modulation rate R can be varied in the range of “0 to 0.78”.

The PWM control includes two control schemes, namely normal PWM control and overmodulation PWM control. The normal PWM control is PWM control in which the amplitude of the AC voltage command values Vu, Vv, and Vw for the three phases (amplitude of the fundamental-wave component), which are generated by the control signal generation section 23 on the basis of the voltage command value, is equal to or less than the amplitude of the carrier waveform. The overmodulation PWM control is PWM control in which the amplitude of the AC voltage command values Vu, Vv, and Vw for the three phases (amplitude of the fundamental-wave component) is more than the amplitude of the carrier waveform. The carrier may be a triangular wave or a sawtooth wave, for example.

The normal PWM control is represented by sinusoidal-wave PWM control. In the embodiment, however, space vector PWM (hereinafter referred to as “SVPWM”) control in which a neutral point bias voltage is applied to a fundamental wave for each phase for the sinusoidal-wave PWM control is used for the normal PWM control. In the SVPWM control, the PWM waveform may be generated directly through digital computation, rather than through comparison with the carrier. In the present invention, such a scheme in which the PWM waveform is generated without using the carrier is also included in the normal PWM control or the overmodulation PWM control, and classified into either of the normal PWM control and the overmodulation PWM control on the basis of the magnitude relationship between the amplitude of the fundamental-wave component of the PWM waveform and the amplitude of an imaginary carrier waveform. That is, the scheme is included in the normal PWM control in the case where the amplitude of the fundamental-wave component of the PWM waveform is equal to or less than the amplitude of the imaginary carrier waveform, and in the overmodulation PWM control in the case where the amplitude of the fundamental-wave component of the PWM waveform is more than the amplitude of the imaginary carrier waveform. In the SVPWM control as the normal PWM control, the modulation rate R can be varied in the range of “0 to 0.707”.

In the overmodulation PWM control, the duty ratio of each pulse is controlled so as to increase at peaks of the fundamental-wave component and so as to reduce at troughs of the fundamental-wave component compared to that in the normal PWM control such that the waveform of the fundamental-wave component of the output voltage waveform of the inverter 6 is deformed to obtain an amplitude that is larger than that in the normal PWM control. In the overmodulation PWM control, the modulation rate R can be varied in the range of “0.707 to 0.78”.

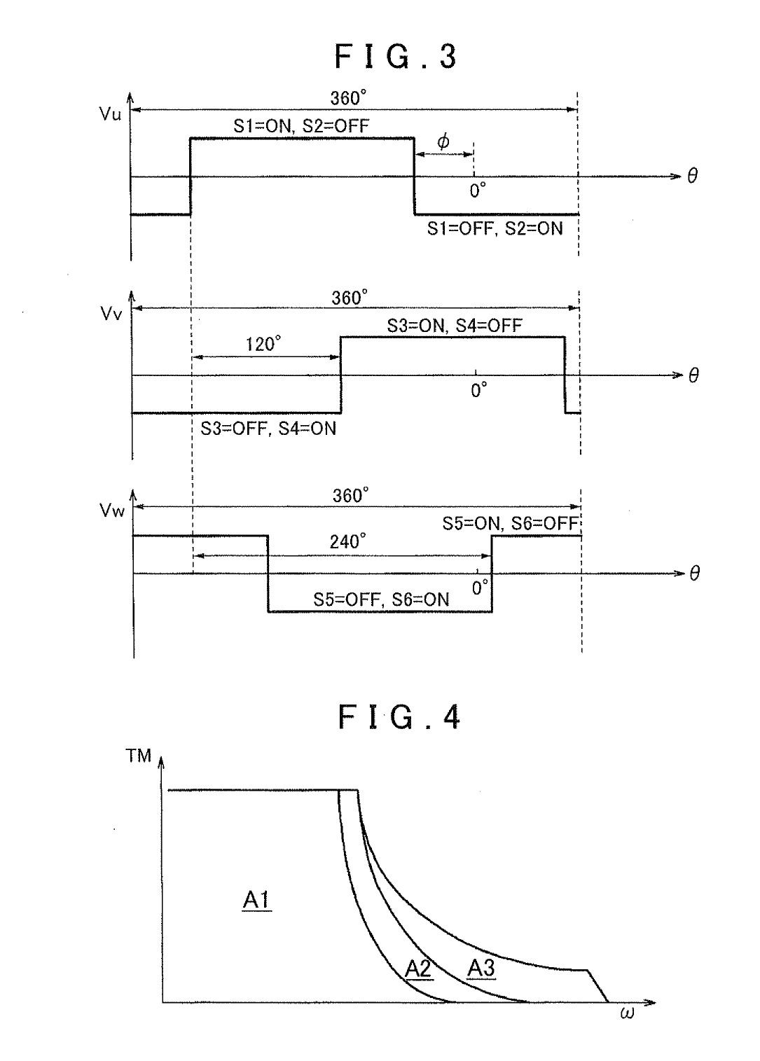

In the rectangular-wave control mode, rotation synchronization control in which each of the switching elements E1 to E6 is turned on and off once each per one cycle of the electrical angle of the electric motor MG and in which one pulse is output for each phase per half a cycle of the electrical angle is performed. Here, the rotation synchronization control is control for synchronizing the cycle of the electrical angle of the electric motor MG and the switching cycle of the inverter 6 with each other. Specifically, in the rectangular-wave control, control is performed such that each of the AC voltage command values Vu, Vv, and Vw for the U-, V-, and W-phases (output voltage waveforms of the inverter 6) is a rectangular wave in which one high-level period per half a cycle of the electrical angle and one low-level period per another half a cycle of the electrical angle alternately appear such that the ratio between the high-level period and the low-level period is 1:1 as shown in FIG. 3. The output voltage waveforms for the respective phases are output with their phases shifted by 120° from each other. Consequently, the inverter 6 outputs a rectangular-wave voltage in the rectangular-wave control. In the rectangular-wave control, the modulation rate R is fixed at “0.78”, which is the maximum modulation rate. In other words, the control mode determination section 20 determines execution of the rectangular-wave control mode when the modulation rate R reaches the maximum modulation rate.

The control device stores a control mode map such as that shown in FIG. 4. The control mode determination section 20 references the control mode map to determine the control mode on the basis of the rotational speed ω and the target torque TM. In the embodiment, as shown in FIG. 4, three areas in which the electric motor MG is operable, namely a first area A1, a second area A2, and a third area A3, are provided in the control mode map.

The control mode determination section 20 determines execution of the PWM control mode in the case where the relationship between the rotational speed ω and the target torque TM is in the first area A1 or the second area A2. As described above, the PWM control includes two control schemes, namely the normal PWM control and the overmodulation PWM control. Thus, in the case where the relationship between the rotational speed ω and the target torque TM is in the first area A1, the control mode determination section 20 determines execution of the PWM control mode, and determines the normal PWM control scheme as the control scheme for the PWM control mode. In the case where the relationship between the rotational speed ω and the target torque TM is in the second area A2, the control mode determination section 20 determines execution of the PWM control mode, and determines the overmodulation PWM control scheme as the control scheme for the PWM control mode. In the case where the relationship between the rotational speed ω and the target torque TM is in the third area A3, the control mode determination section 20 determines execution of the rectangular-wave control mode.

In the embodiment, in field control for adjusting the field magnetic flux of the electric motor MG, maximum torque control and field weakening control can be executed. In the embodiment, the maximum torque control is executed during execution of the PWM control mode based on the normal PWM control scheme, and the field weakening control is executed during execution of the rectangular-wave control mode and the PWM control mode based on the overmodulation PWM control scheme. Here, the maximum torque control is control in which the current phase is adjusted such that the output torque of the electric motor MG becomes maximum for the same current. Meanwhile, the field weakening control is control in which the current phase is adjusted such that the field magnetic flux of the electric motor MG is weakened compared to that in the maximum torque control.

In the embodiment, the modulation rate R derived by the feedback control section 22 or a value derived on the basis of the modulation rate R is input to the control mode determination section 20. Thus, while the control mode determination section 20 basically determines the control mode on the basis of the rotational speed ω and the target torque TM, the control mode determination section 20 can impose certain restrictions on the selection of the control mode on the basis of the modulation rate R or the value associated with the modulation rate R (such as a d-axis current adjustment command value Idm to be described later, for example). In the embodiment, the control mode determination section 20 determines the control mode on the basis of the rotational speed ω and the target torque TM. However, the control mode determination section 20 may be configured to determine the control mode on the basis of the d-axis current adjustment command value Idm, which is set to weaken the field magnetic flux of the electric motor MG in the field weakening control, and the modulation rate R.

Information on the control mode determined by the control mode determination section 20 to be executed is sent to the computation cycle setting section 21. The computation cycle setting section 21 sets the computation cycle of each section on the basis of the type of the determined control mode. The information on the control mode determined by the control mode determination section 20 to be executed is also sent to the feedback control section 22 and the control signal generation section 23. The feedback control section 22 and the control signal generation section 23 perform computation in accordance with the type of the determined control mode.

The computation cycle setting section 21 sets the computation cycle of the control signal generation section 23 on the basis of the control mode determined by the control mode determination section 20 to be executed. In addition, the computation cycle setting section 21 determines the computation cycle of each of an estimated torque value derivation section 31, a torque deviation derivation section 32, and the phase value determination section 33 provided in the torque feedback control section 30 in the case where the control mode determined by the control mode determination section 20 is the rectangular-wave control mode. On the other hand, the computation cycle setting section 21 determines the computation cycle of each of a current command value derivation section 41, a current deviation derivation section 42, and the waveform command value determination section 43 provided in the current feedback control section 40 in the case where the control mode determined by the control mode determination section 20 is the PWM control mode. The computation cycle of each section set by the computation cycle setting section 21 will be described in detail later in Section 1-5.

### 1-2. Configuration of Torque Feedback Control Section

The torque feedback control section 30 is a functional section that performs torque feedback control on the basis of the target torque TM, the actual d-axis current Idr, and the actual q-axis current Iqr to derive the phase value φ of the rectangular-wave voltage (voltage phase) as the voltage command value. In the embodiment, as shown in FIG. 3, the phase value φ of the rectangular-wave voltage is defined as the phase difference between the fall position of the AC voltage command value Vu for U-phase (rectangular wave) in the electrical angle and the origin of the electrical angle. Alternatively, the phase value φ may be defined as the phase difference between the rise position of the AC voltage command value Vu for U-phase (rectangular wave) in the electrical angle and the origin of the electrical angle.

The torque feedback control section 30 includes the estimated torque value derivation section 31, the torque deviation derivation section 32, and the phase value determination section 33. Each section of the torque feedback control section 30 executes a process in each computation cycle set by the computation cycle setting section 21. In the embodiment, as described in detail later, the computation cycle setting section 21 sets the computation cycle of the estimated torque value derivation section 31 and the computation cycle of the torque deviation derivation section 32 to be longer than the computation cycle of the phase value determination section 33. In the embodiment, the torque feedback control section 30 functions to derive the phase value φ in the case where the control mode determined by the control mode determination section 20 is the rectangular-wave control mode. Specifically, the phase value determination section 33 is configured to determine the phase value φ of the rectangular-wave voltage as the voltage command value in the case where the control mode determined by the control mode determination section 20 is the rectangular-wave control mode.

The estimated torque value derivation section 31 is a functional section that derives an estimated torque value TE, which is an estimated value of the output torque (actual output torque) of the electric motor MG, on the basis of the detected values Iur, Ivr, and Iwr of the currents flowing through the coils M (Mu, Mv, and Mw) of the electric motor MG. Although not shown, the control device 1 stores a map (estimated torque value map) of the estimated torque value TB that uses the actual d-axis current Idr and the actual q-axis current Iqr as arguments. As described above, the feedback control section 22, which includes the estimated torque value derivation section 31, receives the actual d-axis current Idr and the actual q-axis current Iqr generated by the three-phase/two-phase conversion section 24 on the basis of the detected current values Iur, Ivr, and Iwr. The estimated torque value derivation section 31 references the estimated torque value map to derive the estimated torque value TE corresponding to the detected current values in the d-q coordinate system (the actual d-axis current Idr and the actual q-axis current Iqr) input from the three-phase/two-phase conversion section 24.

The detected current values Iur, Ivr, and Iwr contain high-frequency noise. Therefore, the estimated torque value derivation section 31 is configured to remove the noise with a low-pass filter in the course of deriving the estimated torque value TE. Such noise removal with a low-pass filter may be performed on the estimated torque value TE derived with reference to the estimated torque value map, or on the detected current values (the U-phase current Iur, the V-phase current Ivr, and the W-phase current Iwr, or the actual d-axis current Idr and the actual q-axis current Iqr).

The torque deviation derivation section 32 is a functional section that derives a deviation ΔT (hereinafter referred to as a “torque deviation”) between the output torque (actual output torque) and the target torque TM of the electric motor MG. In the embodiment, the torque deviation derivation section 32 is configured to derive the torque deviation ΔT between the output torque and the target torque TM of the electric motor MG using the estimated torque value TE derived by the estimated torque value derivation section 31 as the output torque of the electric motor MG.

In the embodiment, in order to obtain good control characteristics, the torque deviation ΔT is derived additionally on the basis of a detected value of an output voltage V of the inverter 6 and a detected value of the rotational speed ω (in the embodiment, the rotational speed ω derived on the basis of a detected value of the magnetic pole position θ). Specifically, the torque deviation ΔT is derived on the basis of the following formula (1):

ΔT=C(TM−TE)·(ω/V) (1)

where C is a constant. By deriving the torque deviation ΔT additionally on the basis of V and ω in this way, the torque deviation ΔT and the difference in phase value φ can be made to be proportional to each other, which provides good control characteristics. The detected value of the output voltage V of the inverter 6 and the detected value of the rotational speed ω may be subjected to noise removal with a low-pass filter.

The phase value determination section 33 performs proportional control and integral control on the basis of the torque deviation ΔT derived by the torque deviation derivation section 32 to determine the phase value φ of the rectangular-wave voltage. Specifically, the phase value determination section 33 performs proportional-integral control computation (PI control computation) on the basis of the torque deviation ΔT to derive the phase value φ as indicated by the following formula (2):

φ=(Kpt+Kit/s)·ΔT (2)

where Kpt is a proportional control gain, Kit is an integral control gain, and s is a Laplace operator. Proportional-integral-differential control computation (PID control computation) may be performed in place of the proportional-integral control computation mentioned above.

Then, the torque feedback control section 30 basically outputs the phase value φ determined by the phase value determination section 33 to the control signal generation section 23 as the derived voltage command value. The torque feedback control section 30 is configured to restrict the phase value φ to a predetermined allowable phase value range. Thus, in the case where the phase value φ determined by the phase value determination section 33 does not fall within the allowable phase value range, the torque feedback control section 30 corrects the phase value φ to an upper limit value or a lower limit value of the allowable phase value range. Specifically, the torque feedback control section 30 outputs the upper limit value of the allowable phase value range to the control signal generation section 23 as the derived voltage command value in the case where the phase value φ determined by the phase value determination section 33 exceeds the upper limit value of the allowable phase value range, and outputs the lower limit value of the allowable phase value range to the control signal generation section 23 as the derived voltage command value in the case where the phase value φ determined by the phase value determination section 33 falls below the lower limit value of the allowable phase value range. The allowable phase value range may be determined from the shape of a phase value-torque curve (not shown) that indicates the relationship between the phase value φ and the torque, for example, and may be set to a range of −90 degrees to 90 degrees or a range of −120 degrees to 120 degrees.

In the embodiment, in order to suppress generation of an over-current due to abrupt variations in phase value φ, the torque feedback control section 30 is configured to restrict the variation rate of the phase value φ to a certain value or less. For example, the difference between the phase value φ last determined by the phase value determination section 33 and the phase value φ currently determined by the phase value determination section 33 may be restricted to 5 degrees or less.

### 1-3. Configuration of Current Feedback Control Section

The current feedback control section 40 is a functional section that performs current feedback control on the basis of the target torque TM, the actual d-axis current Idr, the actual q-axis current Iqr, and the rotational speed ω to derive the AC waveform command value, which is a command value of the waveform of the AC voltage supplied from the inverter 6 to the electric motor MG, as the voltage command value. In the embodiment, the AC waveform command value derived by the current feedback control section 40 includes a d-axis voltage command value Vd and a q-axis voltage command value Vq. In the description below, the d-axis voltage command value Vd and the q-axis voltage command value Vq may be collectively referred to simply as “AC waveform command values Vd and Vq”.

The current feedback control section 40 includes the current command value derivation section 41, the current deviation derivation section 42, and the waveform command value determination section 43. Each section of the current feedback control section 40 executes a process in each computation cycle set by the computation cycle setting section 21. In the embodiment, the computation cycle setting section 21 sets all the computation cycle of the current command value derivation section 41, the computation cycle of the current deviation derivation section 42, and the computation cycle of the waveform command value determination section 43 to be the same as each other. In the embodiment, the current feedback control section 40 functions to derive the AC waveform command values Vd and Vq in the case where the control mode determined by the control mode determination section 20 is the PWM control mode. Specifically, the waveform command value determination section 43 is configured to determine the AC waveform command values Vd and Vq as the voltage command value in the case where the control mode determined by the control mode determination section 20 is the PWM control mode.

The current command value derivation section 41 is a functional section that derives a d-axis current command value Id and a q-axis current command value Iq on the basis of the target torque TM. Specifically, the current command value derivation section 41 references a map, for example, to derive a fundamental d-axis current command value Idb on the basis of the input target torque TM. Here, the fundamental d-axis current command value Idb corresponds to a command value of the d-axis current in the maximum torque control. Then, the d-axis current adjustment command value Idm is subtracted from the fundamental d-axis current command value Idb to derive the d-axis current command value Id. That is, Id=Idb−Idm. The current command value derivation section 41 also references a map, for example, to derive the q-axis current command value Iq on the basis of the target torque TM and the d-axis current adjustment command value Idm.

In the embodiment, as described above, in the field control for adjusting the field magnetic flux of the electric motor MG, the maximum torque control and the field weakening control can be executed. The d-axis current adjustment command value Idm is set to zero in the maximum torque control, and to a positive value in the field weakening control. The method of deriving the d-axis current adjustment command value Idm will be described in the last part of this section.

The current deviation derivation section 42 is a functional section that derives the current deviation on the basis of the d-axis current command value Id and the q-axis current command value Iq derived by the current command value derivation section 41 and the actual d-axis current Idr and the actual q-axis current Iqr derived by the three-phase/two-phase conversion section 24. Specifically, the current deviation derivation section 42 subtracts the actual d-axis current Idr from the d-axis current command value Id to derive a d-axis current deviation ΔId, and subtracts the actual q-axis current Iqr from the q-axis current command value Iq to derive a q-axis current deviation ΔIq.

The waveform command value determination section 43 performs proportional control and integral control on the basis of the current deviations ΔId and ΔIq derived by the current deviation derivation section 42 to determine the AC waveform command value (the d-axis voltage command value Vd and the q-axis voltage command value Vq). Specifically, the waveform command value determination section 43 performs proportional-integral control computation (PI control computation) on the basis of the current deviations ΔId and ΔIq to derive the AC waveform command values Vd and Vq as indicated by the following formulas (3) and (4):

Vd=(Kpd+Kid/s)·ΔId−Eq (3)

Vq=(Kpq+Kiq/s)·ΔIq+Ed+Em (4)

where Kpd and Kpq are proportional control gains for the d-axis and the q-axis, respectively, Kid and Kiq are integral control gains for the d-axis and the q-axis, respectively, and s is a Laplace operator.

In addition, Ed is a d-axis armature reaction, which is given as the product of the rotational speed ω, a d-axis inductance Ld, and the actual d-axis current Idr. Eq is a q-axis armature reaction, which is given, as the product of the rotational speed ω, a q-axis inductance Lq, and the actual q-axis current Iqr. Em is a voltage induced by the armature flux linkage of a permanent magnet (not shown), and is given as the product of an induced voltage constant MIf, which is determined by the effective value of the armature flux linkage of the permanent magnet, and the rotational speed ω. In the embodiment, the permanent magnet is disposed in the rotor. Proportional-integral-derivative control computation (PID control computation) may be performed in place of the proportional-integral control computation mentioned above.

Then, the current feedback control section 40 outputs the AC waveform command value (the d-axis voltage command value Vd and the q-axis voltage command value Vq) determined by the waveform command value determination section 43 to the control signal generation section 23 as the derived voltage command value.

The feedback control section 22 includes a modulation rate derivation section (not shown) that derives the modulation rate R, which is the ratio of the effective value of the fundamental-wave component of the output voltage waveform of the inverter 6 to the DC voltage Vdc. The modulation rate derivation section derives the modulation rate R on the basis of the d-axis voltage command value Vd and the q-axis voltage command value Vq derived by the waveform command value determination section 43 and the value of the DC voltage Vdc detected by the voltage sensor 61 in accordance with the following formula (5):

R=√(Vd²+Vq²)/Vdc (5)

Here, the modulation rate R is derived as a value obtained by dividing the effective value of the three-phase line voltage by the value of the DC voltage Vdc.

Then, the feedback control section 22 multiplies a modulation rate deviation ΔR, which is obtained by subtracting a target modulation rate “0.78” from the modulation rate R, by a predetermined gain to derive a product ΣΔR. Then, in the case where the product ΣΔR is a positive value, the product ΣΔR is multiplied by a proportional coefficient to derive the d-axis current adjustment command value Idm (>0) described above. In the case where the product ΣΔR is a value of zero or less, the d-axis current adjustment command value Idm is set to zero. In the overmodulation PWM control scheme, the target modulation rate may be set to a value in the range of “0.707 to 0.78”.

### 1-4. Configuration of Control Signal Generation Section

The control signal generation section 23 is a functional section that generates the switching control signals S1 to S6 for driving the inverter 6 on the basis of the voltage command value derived by the feedback control section 22. The control signal generation section 23 includes a three-phase voltage command value derivation section 26 and a signal generation section 27. Each section of the control signal generation section 23 executes a process in each computation cycle set by the computation cycle setting section 21. In the embodiment, as described above, in the case where the control mode is the rectangular-wave control mode, the torque feedback control section 30 (phase value determination section 33) derives the phase value φ of the rectangular-wave voltage as the voltage command value, and the control signal generation section 23 generates the switching control signals S1 to S6 on the basis of the phase value φ. Meanwhile, in the case where the control mode is the PWM control mode, the current feedback control section 40 (waveform command value determination section 43) derives the AC waveform command values Vd and Vq as the voltage command value, and the control signal generation section 23 generates the switching control signals S1 to S6 on the basis of the AC waveform command values Vd and Vq.

The three-phase voltage command value derivation section 26 derives the AC voltage command values for the respective phases (the U-phase voltage command value Vu, the V-phase voltage command value Vv, and the W-phase voltage command value Vw) such as those shown in FIG. 3 in accordance with the phase value φ determined by the phase value determination section 33 in the case where the control mode is the rectangular-wave control mode. In the rectangular-wave control mode, the output voltage of the inverter 6 is operable only through the phase value φ. Thus, the AC voltage command values Vu, Vv, and Vw for the respective phases are determined uniquely when the phase value φ is determined as shown in FIG. 3. In the rectangular-wave control mode, the AC voltage command values Vu, Vv, and Vw can be used as command values of phases at which the switching elements E1 to E6 of the inverter 6 are turned on and off. The command values correspond to on/off control signals for the switching elements E1 to E6, and represent the phase of the magnetic pole position θ representing the timings to switch on and off the switching elements E1 to E6.

On the other hand, the three-phase voltage command value derivation section 26 derives the AC voltage command values Vu, Vv, and Vw for the respective phases in accordance with the AC waveform command values Vd and Vq determined by the waveform command value determination section 43 in the case where the control mode is the PWM control mode. Specifically, the three-phase voltage command value derivation section 26 performs two-phase/three-phase conversion on the d-axis voltage command value Vd and the q-axis voltage command value Vq on the basis of the magnetic pole position θ to derive the U-phase voltage command value Vu, the V-phase voltage command value Vv, and the W-phase voltage command value Vw, which are the AC voltage command values for the three phases. In the embodiment, as described above, the PWM control includes the normal PWM control and the overmodulation PWM control. In the case where the control scheme determined by the control mode determination section 20 is the normal PWM control scheme, the three-phase voltage command value derivation section 26 derives the AC voltage command values Vu, Vv, and Vw for the normal PWM control scheme. Meanwhile, in the case where the control scheme determined by the control mode determination section 20 is the overmodulation PWM control scheme, the three-phase voltage command value derivation section 26 derives the AC voltage command values Vu, Vv, and Vw for the overmodulation PWM control scheme.

The signal generation section 27 receives as inputs the U-phase voltage command value Vu, the V-phase voltage command value Vv, and the W-phase voltage command value Vw derived by the three-phase voltage command value derivation section 26. The signal generation section 27 generates the switching control signals S1 to S6 for controlling the switching elements E1 to E6 shown in FIG. 2 in accordance with the AC voltage command values Vu, Vv, and Vw. Then, the inverter 6 respectively turns on and off the switching elements E1 to E6 in accordance with the switching control signals S1 to 56 generated by the signal generation section 27. Consequently, the electric motor MG is subjected to the PWM control (the normal PWM control or the overmodulation PWM control) or the rectangular-wave control.

### 1-5. Computation Cycle of Each Section in Each Control Mode

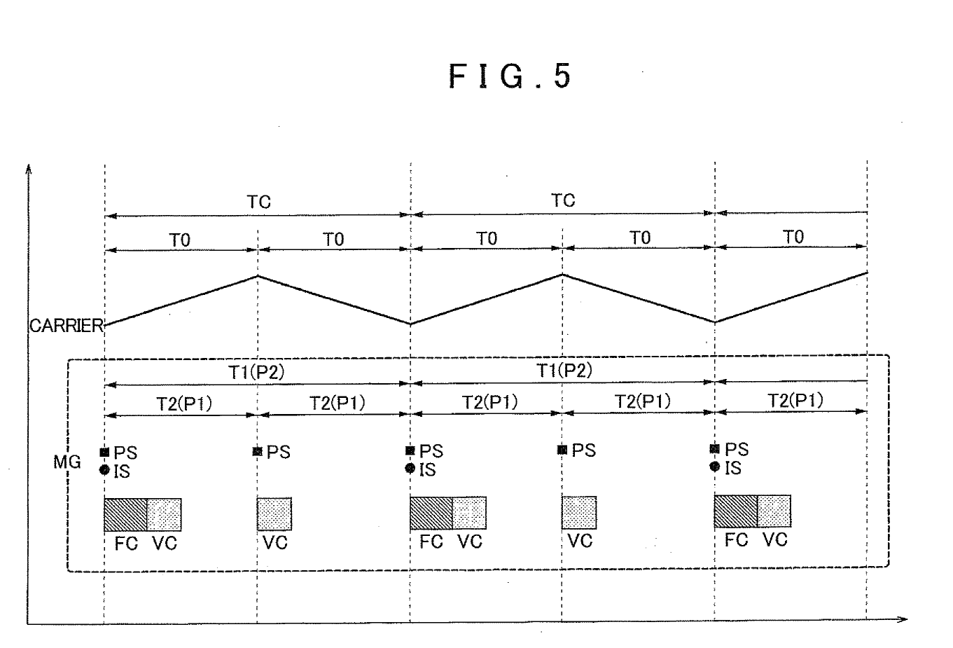

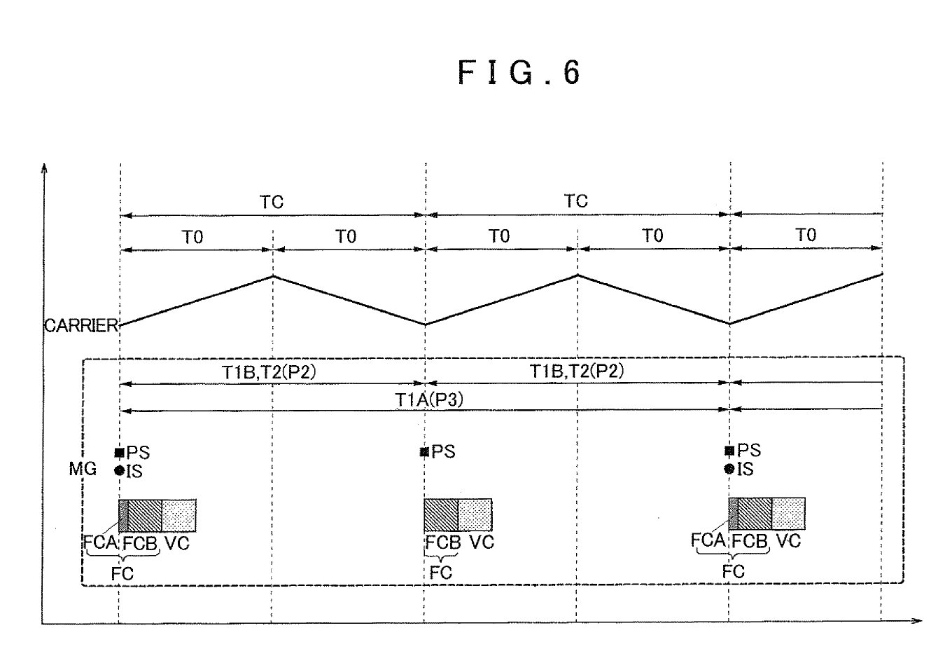

Next, the setting of the computation cycle of each section performed in accordance with each control mode, which is the key feature of the present invention, will be described with respect to FIGS. 5 and 6. In the embodiment, as described above, the control mode determination section 20 is configured to select one of the PWM control mode and the rectangular-wave control mode to determine execution of the selected control mode. The computation cycle setting section 21 is configured to switch the computation cycle of each section including the voltage command value determination section (the phase value determination section 33 and the waveform command value determination section 43) and the control signal generation section 23 in accordance with whether the control mode determined by the control mode determination section 20 is the

PWM control mode or the rectangular-wave control mode. In the embodiment, in the case where the control mode is the PWM control mode, the computation cycle of each section is set irrespective of whether the PWM control scheme is the normal PWM control scheme or the overmodulation PWM control scheme. Each process is executed in accordance with the schedule shown in FIG. 5 in the case where the control mode is the PWM control mode, and in accordance with the schedule shown in FIG. 6 in the case where the control mode is the rectangular-wave control mode.

The CPU 1a of the control device 1 includes a timer (not shown) that counts the time with reference to a predetermined clock cycle. In the embodiment, the timer is configured to monitor the execution cycle of the program on the basis of a reference computation cycle T0, which is set to half a carrier cycle TC as shown in FIGS. 5 and 6, to inform an interrupt controller of the CPU core of the monitoring results. A sequence of control processes (an electric motor control process) performed by the respective sections of the control device 1 is started by an interrupt function of the CPU 1a executed in each reference computation cycle T0.

The carrier, which has a cycle that is twice the reference computation cycle T0, may be the same as or different from the carrier of the PWM waveform in the PWM control mode. In a configuration in which the control device 1 can select a plurality of carriers having cycles that are different from each other as the carrier of the PWM waveform in the PWM control mode, the reference computation cycle T0 may be set to half the cycle of a carrier (reference carrier) that serves as a reference among such carriers. For example, the reference computation cycle T0 may be set to 200 μs.

FIG. 5 is a time chart showing the timing to execute each process in the case where the control mode determined by the control mode determination section 20 is the PWM control mode. In the drawing, “PS” indicates a magnetic pole position detection process performed by the rotation sensor 63, and “IS” indicates a current detection process performed by the current sensors 62. That is, “PS” and “IS” in FIG. 5 respectively indicate the timings at which the magnetic pole position detection process PS and the current detection process IS are executed. This also applies to FIG. 6. The respective execution cycles of the magnetic pole position detection process PS and the current detection process IS are set by the control device 1 in accordance with the control mode.

In FIG. 5, “FC” indicates a feedback control process performed by the feedback control section 22. That is, “FC” in FIG. 5 indicates the timing at which the feedback control process FC is executed. This also applies to FIG. 6. In the PWM control mode, the current feedback control section 40 executes a current feedback control process as described above. The current feedback control process includes a current command value derivation process performed by the current command value derivation section 41, a current deviation derivation process performed by the current deviation derivation section 42, and a waveform command value determination process performed by the waveform command value determination section 43. In the embodiment, the respective computation cycles of the current command value derivation section 41, the current deviation derivation section 42, and the waveform command value determination section 43 are set to be the same as each other. In FIG. 5, the computation cycle of the current feedback control section 40, which includes the current command value derivation section 41, the current deviation derivation section 42, and the waveform command value determination section 43, is indicated as “T1”. That is, the current feedback control process, which includes the current command value derivation process, the current deviation derivation process, and the waveform command value determination process, is executed in each cycle T1. In the embodiment, the cycle T1 corresponds to the “second cycle P2” according to the present invention.

In FIG. 5, “VC” indicates a control signal generation process performed by the control signal generation section 23. That is, “VC” in FIG. 5 indicates the timing at which the control signal generation process VC is executed. This also applies to FIG. 6. The control signal generation process includes a three-phase voltage command value derivation process performed by the three-phase voltage command value derivation section 26 and a signal generation process performed by the signal generation section 27. In the embodiment, the respective computation cycles of the three-phase voltage command value derivation section 26 and the signal generation section 27 are set to be the same as each other. In FIG. 5, the computation cycle of the control signal generation section 23, which includes the three-phase voltage command value derivation section 26 and the signal generation section 27, is indicated as “T2”. That is, the control signal generation process VC, which includes the three-phase voltage command value derivation process and the signal generation process, is executed in each cycle T2. In the embodiment, the cycle T2 corresponds to the “first cycle P1” according to the present invention.

In FIG. 5, in order to facilitate understanding of the present invention, the timing at which each process (each computation process) of the feedback control process FC and the control signal generation process VC is executed is represented by a rectangular area. However, such rectangles do not represent the exact timing of the respective processes, but indicate that the processes corresponding to the rectangles are executed in the reference computation cycle T0 in which the rectangles are included. A set of a plurality of rectangles disposed in the same reference computation cycle T0 mean that a process corresponding to a rectangle disposed on the left side is executed earlier than a process corresponding to a rectangle disposed on the right side. This also applies to FIGS. 6, 8, and 9 to be referenced later.

The term “computation cycle” as used herein is defined without considering the timing in a reference computation cycle T0 at which each of identical processes performed repeatedly is executed. That is, the computation cycle of a functional section that repeatedly executes certain computation processes means the intervals (temporal length) between the reference computation cycles T0 in which the respective computation processes are executed.

As is clear from FIG. 5, in the case where the control mode is the PWM control mode, the computation cycle T2 (first cycle P1) of the control signal generation section 23 is set to be equal to the reference computation cycle T0. That is, in the embodiment, the first cycle P1 is set to be the same as the reference computation cycle with “N” according to the present invention set to “1”. Also, the computation cycle T1 (second cycle P2) of the current feedback control section 40 is set to twice the reference computation cycle T0. That is, in the embodiment, the second cycle P2 is set to twice the first cycle P1 with “M” according to the present invention set to “2”.

If the computation cycles are set as described above, there exist reference computation cycles T0 in which the feedback control process FC is not executed but in which the control signal generation process VC is executed as shown in FIG. 5. In such reference computation cycles T0, the control signal generation process VC is executed on the basis of the AC waveform command values Vd and Vq derived in the preceding feedback control process FC.

In the case where the control mode is the PWM control mode, the current values Iur, Ivr, and Iwr detected by the current sensors 62 are used in the process for deriving the current deviations ΔId and ΔIq performed by the current deviation derivation section 42. In the embodiment, in order to enhance the capability of the AC waveform command values Vd and Vq, which are derived on the basis of the current deviations ΔId and ΔIq, to follow variations in currents flowing through the coils M, the update cycle of the detected current values Iur, Ivr, and Iwr (execution cycle of the current detection process IS) is set to be equal to the computation cycle T1 of the current feedback control section 40. Specifically, as shown in FIG. 5, the current detection process IS is executed at the starting point of the reference computation cycle T0 in which the feedback control process FC is executed. The execution cycle of the current detection process IS may be set to be longer than the cycle T1, and the feedback control process FC executed in the reference computation cycle T0, at the starting point of which the current detection process IS is not executed, may be performed on the basis of the detection results of the current detection process IS executed at the starting point of a previous reference computation cycle T0.

On the other hand, the value of the magnetic pole position θ detected by the rotation sensor 63 is used in the control signal generation process performed by the control signal generation section 23. In the embodiment, in order for the control signal generation section 23 to generate the switching control signals S1 to S6 on the basis of a more accurate magnetic pole position θ, the update cycle of the magnetic pole position θ (execution cycle of the magnetic pole position detection process PS) is set to be equal to the computation cycle T2 of the control signal generation section 23. Specifically, as shown in FIG. 5, the magnetic pole position detection process PS is executed at the starting point of the reference computation cycle T0 in which the control signal generation process VC is executed. The execution cycle of the magnetic pole position detection process PS may be set to be longer than the cycle T2, and the control signal generation process VC executed in the reference computation cycle T0, at the starting point of which the magnetic pole position detection process PS is not executed, may be performed using a value predicted on the basis of the detection results of the magnetic pole position detection process PS executed at the starting point of a previous reference computation cycle T0. For example, the execution cycle of the magnetic pole position detection process PS may be set to the cycle T1, and the magnetic pole position detection process PS may be executed only at the starting point of the reference computation cycle T0 in which the feedback control process FC is executed.

Next, the case where the control mode determined by the control mode determination section 20 is the rectangular-wave control mode will be described with reference to FIG. 6. The same elements as those in the case of the PWM control mode described with reference to FIG. 5 will not be specifically described. In the rectangular-wave control mode, as described above, a torque feedback control process is performed by the torque feedback control section 30 as the feedback control process. The torque feedback control process includes an estimated torque value derivation process performed by the estimated torque value derivation section 31, a torque deviation derivation process performed by the torque deviation derivation section 32, and a phase value determination process performed by the phase value determination section 33. In FIG. 6, “FCA” indicates the estimated torque value derivation process and the torque deviation derivation process (which may hereinafter be collectively referred to as a “first feedback control process”), and “FCB” indicates the phase value determination process (which may hereinafter be referred to as a “second feedback control process”). That is, “FCA” and “FCB” in FIG. 6 respectively indicate the timings at which the first feedback control process FCA and the second feedback control process FCB are executed. The feedback control process FC is divided into the first feedback control process FCA and the second feedback control process FCB in this way because the execution cycle of the first feedback control process FCA and the execution cycle of the second feedback control process FCB are set to be different from each other in the embodiment as described later.

In FIG. 6, the respective computation cycles of the estimated torque value derivation section 31 and the torque deviation derivation section 32, which execute the first feedback control process FCA, are indicated as “T1A”. That is, the estimated torque value derivation process and the torque deviation derivation process, each of which forms a part of the torque feedback control process, are executed in each cycle T1A. In the embodiment, the cycle T1A corresponds to the “third cycle P3” according to the present invention. As shown in FIG. 6, the cycle T1A (third cycle P3) is set to four times the reference computation cycle T0, in other words, twice the second cycle P2. That is, in the embodiment, the third cycle P3 is set to twice the second cycle P2 with “L” according to the present invention set to “2”.

In FIG. 6, the computation cycle of the phase value determination section 33, which executes the second feedback control process FCB, is indicated as “T1B”. That is, the phase value determination process, which forms the remaining part of the torque feedback control process, is executed in each cycle T1B. The cycle T1B is set to be the same as the second cycle P2. Specifically, in the embodiment, as described above, the second cycle P2 is set to twice the reference computation cycle T0, and the cycle T1B is also set to twice the reference computation cycle T0.

The execution cycle TI A of the first feedback control process FCA is set to be longer than the execution cycle T1B of the second feedback control process FCB in this way because variations in estimated torque value TE and torque deviation ΔT within a period that corresponds to the reference computation cycle T0 are so slow that the control characteristics of the electric motor MG can be maintained at a good level even if the first feedback control process FCA is partially omitted. In the case where the integral control gain Kit (see the above formula (2)), which is used by the phase value determination section 33 to derive the phase value φ, is updated in predetermined computation cycles, variations in integral control gain Kit within a period that corresponds to the reference computation cycle T0 are also so slow. Therefore, the update cycle of the integral control gain Kit may be set to the third cycle P3.

If the computation cycles of the respective sections of the torque feedback control section 30 are set as described above, there exist reference computation cycles T0 in which the first feedback control process FCA is not executed but in which the second feedback control process FCB is executed as shown in FIG. 6. In such reference computation cycles T0, the phase value determination process (PI control computation based on the above formula (2)) is executed without updating the torque deviation ΔT. That is, in the embodiment, a single torque deviation ΔT derived by the torque deviation derivation section 32 is used to perform two PI control computations.

In the rectangular-wave control mode, as shown in FIG. 6, the computation cycle T2 of the control signal generation section 23 is set to twice the reference computation cycle T0, unlike in the PWM control mode (see FIG. 5). In other words, the computation cycle T2 of the control signal generation section 23 in the rectangular-wave control mode is set to twice the computation cycle T2 of the control signal generation section 23 in the PWM control mode. That is, the control signal generation process VC in the rectangular-wave control mode is partially omitted in frequency compared to that in the PWM control mode. The rectangular-wave control mode provides a smaller number of points for switching on and off the switching elements E1 to E6, per one cycle of the electrical angle, that allow changes of the AC voltage command values Vu, Vv, and Vw to be reflected than the number of such points provided in the PWM control mode. Therefore, in the rectangular-wave control mode, the control characteristics of the electric motor MG can be maintained at a good level even if the control signal generation process VC is partially omitted.

In the embodiment, as described above, the first feedback control process FCA is partially omitted and the control signal generation process VC is partially omitted in the rectangular-wave control mode. This makes it possible to reduce the computation load on the CPU 1a of the control device 1 while suppressing degradation of the control characteristics of the electric motor MG

In the case where the control mode is the rectangular-wave control mode, the current values Iur, Ivr, and Iwr detected by the current sensors 62 are used by the estimated torque value derivation section 31 to derive the estimated torque value TE. In the embodiment, in order to enhance the capability of the estimated torque value TE, which is derived by the estimated torque value derivation section 31, to follow variations in currents flowing through the coils M, the update cycle of the detected current values Iur, Ivr, and Iwr (execution cycle of the current detection process IS) is set to be equal to the computation cycle T1A of the estimated torque value derivation section 31. Specifically, as shown in FIG. 6, the current detection process IS is executed at the starting point of the reference computation cycle T0 in which the first feedback control process FCA is executed, The execution cycle of the current detection process IS may be set to be longer than the cycle T1A, and the estimated torque value derivation process executed in the reference computation cycle T0, at the starting point of which the current detection process IS is not executed, may be performed on the basis of the detection results of the current detection process IS executed at the starting point of a previous reference computation cycle T0.

On the other hand, the value of the magnetic pole position θ detected by the rotation sensor 63 is used in the control signal generation process performed by the control signal generation section 23. In the embodiment, in order for the control signal generation section 23 to generate the switching control signals S1 to S6 on the basis of a more accurate magnetic pole position θ, the update cycle of the magnetic pole position θ (execution cycle of the magnetic pole position detection process PS) is set to be equal to the computation cycle T2 of the control signal generation section 23. Specifically, as shown in FIG. 6, the magnetic pole position detection process PS is executed at the starting point of the reference computation cycle T0 in which the control signal generation process VC is executed. The execution cycle of the magnetic pole position detection process PS may be set to be longer than the cycle T2, and the control signal generation process VC executed in the reference computation cycle T0, at the starting point of which the magnetic pole position detection process PS is not executed, may be performed using a value predicted on the basis of the detection results of the magnetic pole position detection process PS executed at the starting point of a previous reference computation cycle T0.

The time charts of FIGS. 5 and 6 do not include a control mode determination process performed by the control mode determination section 20. Because the update cycle of an input variable required for the control mode determination process (for example, the target torque TM) is sufficiently longer than the reference computation cycle T0, and it is not necessary to perform the computation process for such an input variable so frequently, the computation cycle of the control mode determination process is set to be longer than those of the respective processes described above. Thus, although not shown, the control mode determination process is executed utilizing an unoccupied time in which the respective processes described above are not performed in the reference computation cycle T0. In the case where the control mode determination process is not completed in a single reference computation cycle T0, the control mode determination process is executed in a divided manner in a plurality of reference computation cycles T0.

### 1-6. Procedures of Electric Motor Control Process

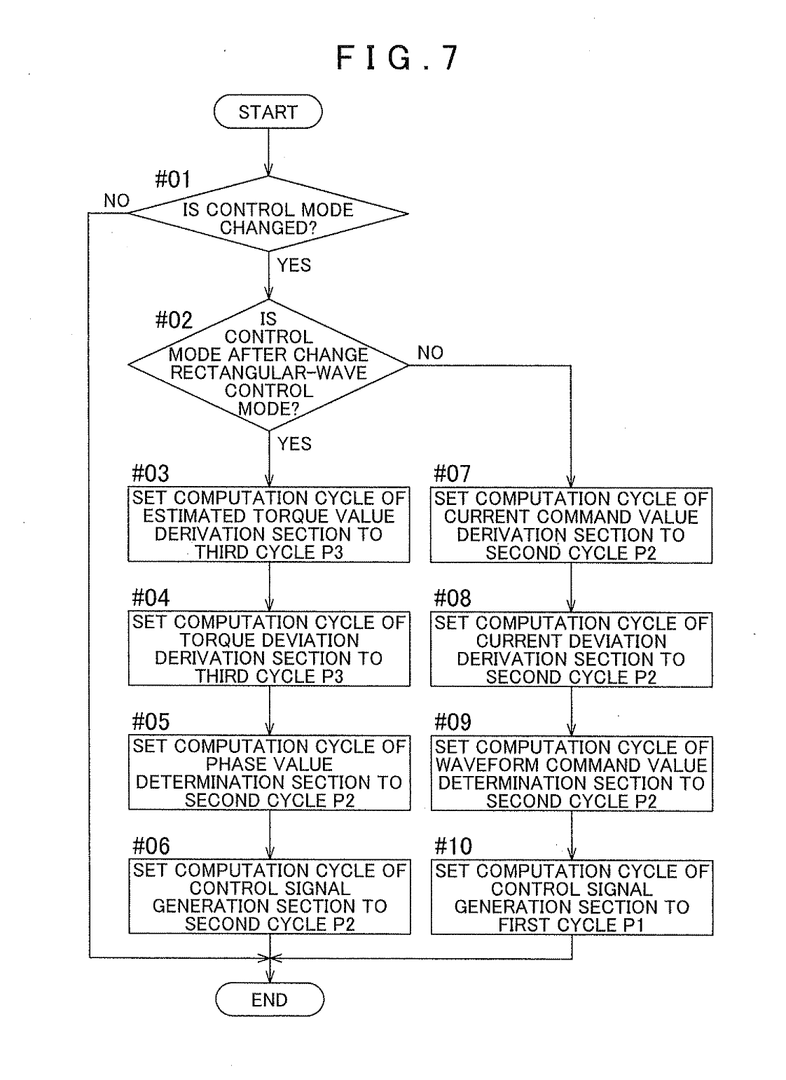

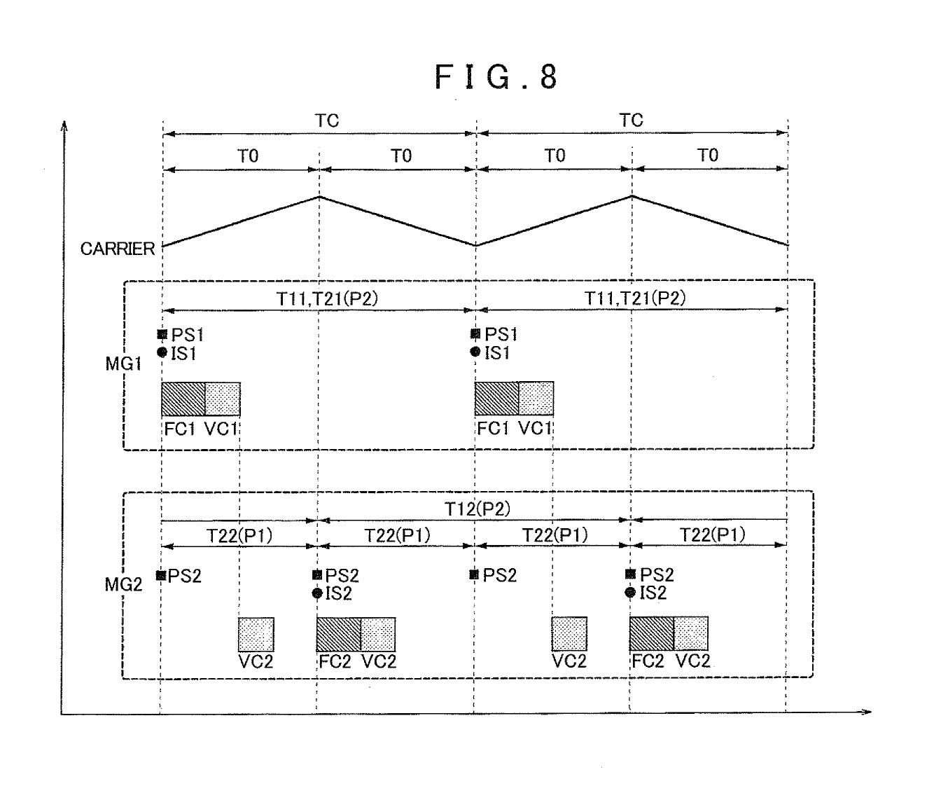

Next, the procedures of an electric motor control process, specifically a computation cycle setting process executed by the computation cycle setting section 21, according to the embodiment will be described with reference to the flowchart of FIG. 7. The respective processes of the computation cycle setting process described below are executed by the computation cycle setting section 21. In the embodiment, the respective functional sections including the computation cycle setting section 21 are formed by the electric motor control program stored in the memory (program memory) of the CPU 1a. Hence, in the embodiment, the CPU 1a operates as a computer that executes the electric motor control program (computation cycle setting program).

The computation cycle setting section 21 receives as an input information on the control mode determined by the control mode determination section 20 to be executed. In the case where the control mode is not changed (step #01: Yes), it is determined whether or not the control mode after the change is the rectangular-wave control mode (step #02). In the case where the control mode after the change is the rectangular-wave control mode (step #02: Yes), processes in steps #03 to #06 are sequentially executed. In the case where the control mode after the change is not the rectangular-wave control mode, that is, the control mode after the change is the PWM control mode (step #02: No), processes in steps #07 to #10 are sequentially executed. In the case where the control mode is not changed in the determination of step #01 (step #01: No), the process is terminated.

The respective processes in steps #03 to #06 are sequentially executed in the case where the control mode after the change is the rectangular-wave control mode (step #02: Yes) as described above. Specifically, the computation cycle of the estimated torque value derivation section 31 is set to the third cycle P3 (step #03). The computation cycle of the torque deviation derivation section 32 is set to the third cycle P3 (step #04). The computation cycle of the phase value determination section 33 is set to the second cycle P2 (step #05). The computation cycle of the control signal generation section 23 is set to the second cycle P2 (step #06). Then, the process is terminated. The execution order of the respective processes in steps #03 to #06 may be changed appropriately. In the embodiment, the second cycle P2 is set to twice (M=2) the first cycle P1, and the third cycle P3 is set to twice (L=2) the second cycle P2.

Meanwhile, the respective processes in steps #07 to #10 are sequentially executed in the case where the control mode after the change is not the rectangular-wave control mode (step #02: No) as described above. Specifically, the computation cycle of the current command value derivation section 41 is set to the second cycle P2 (step #07), the computation cycle of the current deviation derivation section 42 is set to the second cycle P2 (step #08), the computation cycle of the waveform command value determination section 43 is set to the second cycle P2 (step #09), and the computation cycle of the control signal generation section 23 is set to the first cycle P1 (step #10). Then, the process is terminated. The execution order of the respective processes in steps #07 to #10 may be changed appropriately. In the embodiment, the first cycle P1 is set to be the same (N=1) as the reference computation cycle T0, which is set to half the carrier cycle TC.

### 2. Second Embodiment

Next, a control device according to a second embodiment of the present invention will be described. The control device 1 according to the embodiment controls M (M is an integer of 2 or more) electric motors MG, unlike the control device 1 according to the above first embodiment which controls a single electric motor MG. Therefore, although not shown, the electric motor drive device 2 according to the embodiment includes M inverters 6, M sets of current sensors 62, and M rotation sensors 63, unlike the control device 1 according to the above first embodiment. In the embodiment, the M electric motors MG are each an interior permanent magnet synchronous motor (IPMSM) that operates on three-phase AC. Here, an exemplary case where “M” is “2” will be described. That is, in the embodiment, the second cycle P2 is set to twice the first cycle P1, as in the above first embodiment. The differences between the control device 1 according to the embodiment and the control device 1 according to the above first embodiment will be mainly described below. The same elements as those in the above first embodiment will not be specifically described.

In the embodiment, the electric motor drive device 2, which is controlled by the control device 1, includes two inverters 6 that control driving of two electric motors MG (a first electric motor MG1 and a second electric motor MG2), respectively. Hence, the control device 1 includes the respective functional sections shown in FIG. 1 for each of the two inverters 6. The respective functional sections perform the same processes on each of the two inverters 6, and the processes performed on each of the inverters 6 are the same as those according to the first embodiment. Therefore, the respective functional sections will not be described in detail here.

The first electric motor MG1 and the second electric motor MG2, which are controlled by the electric motor drive device 2, may have the same performance as or difference performances from each other. The first electric motor MG1 is connected to the DC power source 3 via one of the two inverters 6 of the electric motor drive device 2. The second electric motor MG2 is connected to the DC power source 3 via the other of the two inverters 6 of the electric motor drive device 2.

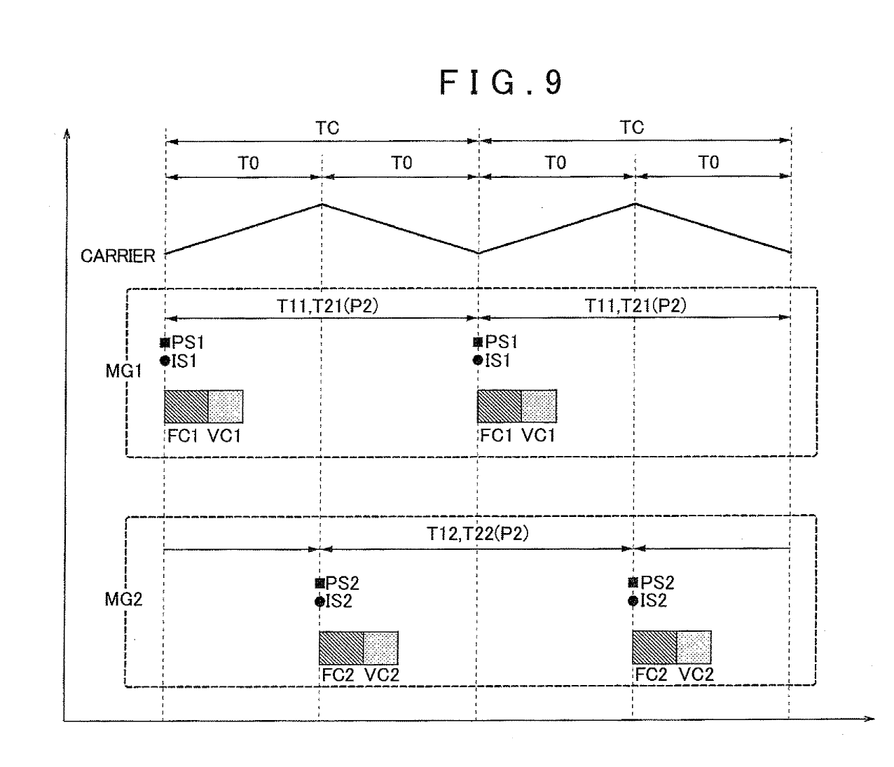

Various computation processes including computation processes for determining the voltage command value through the voltage command value determination sections (the phase value determination sections 33 and the waveform command value determination sections 43) for the two electric motors MG1 and MG2 are performed by the CPU 1 a of the control device 1. That is, the control device 1 is configured to control the two inverters 6 using the CPU 1a, which serves as a single computation processing unit. In such a configuration in which a plurality of (in the embodiment, two) inverters 6 are controlled using a single computation processing unit, it is necessary to bring the overall computation load for controlling the electric motor drive device 2 within the range of the processing power of the CPU 1a. In the embodiment, as described below, the schedule for controlling the electric motors MG is set such that a process that requires a high computation load for the first electric motor MG1 and a process that requires a high computation load for the second electric motor MG2 are not executed in the same reference computation cycle T0. This will be described below with reference to FIGS. 8 and 9.

FIG. 8 shows the schedule for executing each process for the electric motors MG in the case where the first electric motor MG1 is controlled in the rectangular-wave control mode and the second electric motor MG2 is controlled in the PWM control mode. FIG. 9 shows the schedule for executing each process for the electric motors MG in the case where both the first electric motor MG1 and the second electric motor MG2 are controlled in the rectangular-wave control mode.

Here, “PS*” indicates the magnetic pole position detection process performed by the rotation sensor 63, as in the above first embodiment. Here, “*” indicates one of numerals “1” and “2”, which represent the first electric motor MG1 and the second electric motor MG2, respectively. That is, “PS1” and “PS2” indicate the magnetic pole position detection processes for the first electric motor MG1 and the second electric motor MG2, respectively. Likewise, “IS*” indicates the current detection process performed by the current sensors 62, as in the above first embodiment. “IS1” and “IS2” indicate the current detection processes for the first electric motor MG1 and the second electric motor MG2, respectively.

In addition, “FC*” indicates the feedback control process performed by the feedback control section 22, as in the above first embodiment. “FC1” and “FC2” indicate the feedback control processes for the first electric motor MG1 and the second electric motor MG2, respectively. Likewise, “VC*” indicates the control signal generation process performed by the control signal generation process 23, as in the above first embodiment. “VC1” and “VC2” indicate the control signal generation processes for the first electric motor MG1 and the second electric motor MG2, respectively.

In the embodiment, unlike in the above embodiment, in the case where the control mode determined by the control mode determination section 20 is the rectangular-wave control mode, the computation cycle setting section 21 sets the respective computation cycles of the estimated torque value derivation section 31 and the torque deviation derivation section 32 to the second cycle P2, as with the computation cycle of the phase value determination section 33. Therefore, in FIGS. 8 and 9, it is not necessary to divide the feedback control process FC performed by the torque feedback control section 30 into the first feedback control process FCA and the second feedback control process FCB as in FIG. 6, and thus the feedback control process FC is simply indicated as “F′C*”.

In addition, the cycle “T1*” indicates the execution cycle of the feedback control process. “T11” and “T12” indicate the execution cycles of the feedback control processes for the first electric motor MG1 and the second electric motor MG2, respectively. Likewise, the cycle “T2*” indicates the execution cycle of the control signal generation process. “T21” and “T22” indicate the execution cycles of the control signal generation processes for the first electric motor MG1 and the second electric motor MG2, respectively.

As described above, the second electric motor MG2 in FIG, 8 is controlled in the PWM control mode. Also in the embodiment, as shown in FIG. 8, in the case where the control mode is the PWM control mode, the computation cycle T22 (first cycle P1) of the control signal generation section 23 is set to be equal to the reference computation cycle T0, as in the above first embodiment. That is, also in the embodiment, the first cycle P1 is set to be the same as the reference computation cycle with “N” according to the present invention set to “1”. Also, in the case where the control mode is the PWM control mode, the computation cycle T12 (second cycle P2) of the waveform command value determination section 43, which serves as the voltage command value determination section, is set to twice the reference computation cycle T0. That is, in the embodiment, the second cycle P2 is set to twice the first cycle P1 with “M” set to “2”.

Meanwhile, the first electric motor MG1 in FIG. 8 is controlled in the rectangular-wave control mode. In the case where the control mode is the rectangular-wave control mode, the computation cycle T11 of the phase value determination section 33, which serves as the voltage command value determination section, and the computation cycle T21 of the control signal generation section 23 are both set to the second cycle P2.

The feedback control process FC performed by the feedback control section 22 tends to require a high computation load compared to that required by the control signal generation process VC performed by the control signal generation section 23. With this in view, in the embodiment, as shown in FIG. 8, the feedback control process FC1 for the first electric motor MG1 and the feedback control process FC2 for the second electric motor MG2 are executed in the reference computation cycles T0 that are different from each other. That is, computations through the respective voltage command value determination sections for the M (in the embodiment, M=2) electric motors MG1 and MG2 are performed in the second cycles P2 and in the reference computation cycles T0 that are different from each other. In other words, computation through the voltage command value determination section (in the example of FIG. 8, the phase value determination section 33) for the first electric motor MG1 and computation through the voltage command value determination section (in the example of FIG. 8, the waveform command value determination section 43) for the second electric motor MG2 are performed in the second cycles P2 and in the reference computation cycles T0 that are different from each other.

Specifically, the execution cycle T11 of the feedback control process FC1 for the first electric motor MG1 and the execution cycle T12 of the feedback control process FC2 for the second electric motor MG2 are both set to the second cycle P2, but are shifted by half a cycle (by a reference computation cycle T0) from each other. That is, the execution cycle T11 and the execution cycle T12 are set such that the reference computation cycles T0 in which the feedback control process FC1 for the first electric motor MG1 is executed and the reference computation cycles T0 in which the feedback control process FC2 for the second electric motor MG2 is executed appear alternately. Consequently, a process that requires a high computation load for the first electric motor MG1 and a process that requires a high computation load for the second electric motor MG2 are executed in the reference computation cycles T0 that are different from each other, which makes it easy to bring the overall computation load for controlling the electric motor drive device 2 within the range of the processing power of the CPU 1a.

If settings are performed as described above, there exist reference computation cycles T0 in which the feedback control process FC1 for the first electric motor MG1, the control signal generation process VC1 for the first electric motor MG1, and the control signal generation process VC2 for the second electric motor MG2 are executed. In the embodiment, as shown in FIG. 8, the feedback control process FC1, the control signal generation process VC1, and the control signal generation process VC2 are sequentially executed in such reference computation cycles T0. The order of the processes may be changed appropriately.

Although not described in detail, as shown in FIG. 9, in the case where both the first electric motor MG1 and the second electric motor MG2 are controlled in the rectangular-wave control mode, likewise, computation through the voltage command value determination section (in the example of FIG. 9, the phase value determination section 33) for the first electric motor MG1 and computation through the voltage command value determination section (in the example of FIG. 9, the phase value determination section 33) for the second electric motor MG2 are performed in the second cycles P2 and in the reference computation cycles T0 that are different from each other. Also, although not shown, in the case where both the first electric motor MG1 and the second electric motor MG2 are controlled in the PWM control mode, likewise, computation through the voltage command value determination section (the waveform command value determination section 43) for the first electric motor MG1 and computation through the voltage command value determination section (the waveform command value determination section 43) for the second electric motor MG2 are performed in the second cycles P2 and in the reference computation cycles T0 that are different from each other.

### 3. Other Embodiments

Lastly, other embodiments of the present invention will be described. The characteristics disclosed in each of the following embodiments are not only applicable to that particular embodiment but also to any other embodiment unless any contradiction occurs.

(1) In the above first embodiment, “N” is set to “1”, “M” is set to “2”, and “L” is set to “2”. However, the present invention is not limited thereto. “N” may be set to any integer of 1 or more, “M” may be set to any integer of 2 or more, and “L” may be set to any integer of 2 or more. These values may be set in accordance with the characteristics and the state (such as rotational speed) of the electric motor MG, the required level of the control characteristics, the length of the reference computation cycle T0, the performance of the computation processing unit, or the like, for example. For example, “L” may be set to “3”.

(2) In the above first embodiment, in the case where the control mode determined by the control mode determination section 20 is the rectangular-wave control mode, the respective computation cycles of the estimated torque value derivation section 31 and the torque deviation derivation section 32 are set to the third cycle P3, which is L times (L=2) the second cycle P2. However, the present invention is not limited thereto. The respective computation cycles of the estimated torque value derivation section 31 and the torque deviation derivation section 32 may be set to the second cycle P2, as with the computation cycle of the phase value determination section 33. That is, the execution cycle of the first feedback control process FCA and the execution cycle of the second feedback control process FCB may be set to be the same as each other.

(3) In the above second embodiment, “N” is set to “1”, and “M” is set to “2”. However, the present invention is not limited thereto. “N” may be set to any integer of 1 or more, and “M” may be set to any integer of 2 or more. These values may be set in accordance with the characteristics and the state (such as rotational speed) of the electric motors MG, the required level of the control characteristics, the length of the reference computation cycle T0, or the performance of the computation processing unit, for example.

(4) In the above second embodiment, the respective computation cycles of the estimated torque value derivation section 31 and the torque deviation derivation section 32 are set to the second cycle P2, as with the computation cycle of the phase value determination section 33. However, the present invention is not limited thereto. In one suitable embodiment of the present invention, as in the above first embodiment, in the case where the control mode determined by the control mode determination section 20 is the rectangular-wave control mode, the respective computation cycles of the estimated torque value derivation section 31 and the torque deviation derivation section 32 may be set to the third cycle P3, which is L times (L is an integer of 2 or more) the second cycle P2. For example, “L” may be set to “2” or “3”.

(5) In the above first and second embodiments, the estimated torque value derivation section 31 references the estimated torque value map to derive the estimated torque value TE. However, the present invention is not limited thereto. In one suitable embodiment of the present invention, the estimated torque value derivation section 31 may be configured to derive the estimated torque value TE from the detected current values in the d-q coordinate system (the actual d-axis current Idr and the actual q-axis current Iqr) on the basis of a formula. As the formula, for example, the following formula (6) may be used:

TE=P·Q·Iqr+P·(Ld−Lq)·Idr·Iqr (6)

where P, Q, Ld, and Lq are the number of pole pairs, a counter electromotive voltage constant, a d-axis inductance, and a q-axis inductance, respectively.

In place of using the above formula, electric power may be derived on the basis of a detected current value and a voltage (a voltage command value or a detected voltage value), and the electric power may be divided by the rotational speed ω to derive the estimated torque value TE.

Further, the torque feedback control section 30 may receive as inputs the detected current values Iur, Ivr, and Iwr for the three phases, and the estimated torque value derivation section 31 may derive the estimated torque value TE with reference to a map or through computation that uses a formula on the basis of the U-phase current Iur, the V-phase current Ivr, and the W-phase current Iwr.

(6) In the above first and second embodiments, the feedback control section 22 includes the torque feedback control section 30, and the voltage command value is derived by the torque feedback control section 30 in the case where the control mode determined by the control mode determination section 20 is the rectangular-wave control mode. However, the present invention is not limited thereto. In one suitable embodiment of the present invention, the voltage command value may be derived through the current feedback control process performed by the current feedback control section 40 also in the case where the control mode determined by the control mode determination section 20 is the rectangular-wave control mode, as in the case where the control mode determined by the control mode determination section 20 is the pulse width modulation control mode. In this configuration, for an electric motor MG for which the control mode determined by the control mode determination section 20 is the rectangular-wave control mode, the computation cycle of the current feedback control section 40 (waveform command value determination section 43), the computation cycle of the control signal generation section 23, and the respective execution cycles of the magnetic pole position detection process PS and the current detection process IS may be set in the same way as for MG1 in FIG. 8. That is, the computation cycle of the current feedback control section 40 (waveform command value determination section 43), the computation cycle of the control signal generation section 23, and the respective execution cycles of the magnetic pole position detection process PS and the current detection process IS may all be set to the second cycle P2.

(7) In the above first and second embodiments, the control device 1 includes the estimated torque value derivation section 31, and the torque deviation derivation section 32 is configured to derive the deviation between the output torque and the target torque TM of the electric motor MG using the estimated torque value TE derived by the estimated torque value derivation section 31 as the output torque. However, the present invention is not limited thereto. In the case where the electric motor drive device 2 includes a torque sensor that detects the output torque (actual output torque) of the electric motor MG, the torque deviation derivation section 32 may be configured to derive the deviation between the output torque and the target torque TM of the electric motor MG using the detection results of the torque sensor as the output torque. In this case, the control device 1 may be configured not to include the estimated torque value derivation section 31.

(8) In the above first and second embodiments, the torque deviation derivation section 32 derives the torque deviation ΔT on the basis of the formula (1). However, the present invention is not limited thereto. The torque deviation ΔT may be derived on the basis of ΔT=TM−TE.

(9) In the above first and second embodiments, the voltage command value is determined through feedback computation (current feedback computation and torque feedback computation) performed on the basis of the target torque TM. However, the present invention is not limited thereto. The voltage command value may be determined by executing feedforward computation in addition to the feedback computation, or by executing only feedforward computation. The voltage command value may also be determined through computation other than feedback computation or feedforward computation.

(10) In the above second embodiment, computation processes for determining the voltage command value through the voltage command value determination sections (the phase value determination sections 33 and the waveform command value determination sections 43) for M (M is an integer of 2 or more), that is, a plurality of (in the above second embodiment, two) electric motors MG are performed by the CPU 1a, which serves as a single computation processing unit, and computations through the respective voltage command value determination sections for the plurality of electric motors MG are performed in the second cycles P2 and in the reference computation cycles T0 that are different from each other. However, the present invention is not limited thereto. The control device 1 may include a plurality of computation processing units, and computation processes for determining the voltage command value through the voltage command value determination sections (the phase value determination sections 33 and the waveform command value determination sections 43) for the plurality of electric motors MG may be performed by the plurality of computation processing units. In this case, computations through the respective voltage command value determination sections for the plurality of electric motors MG may be performed in the reference computation cycles T0 that are the same as or different from each other. Even in the case where a computation process for determining the voltage command value is performed by a single computation processing unit, computations through the respective voltage command value determination sections for the plurality of electric motors MG may be performed in the second cycles P2 and in the reference computation cycles T0 that are the same as each other, depending on the performance of the computation processing unit.

(11) In the above first and second embodiments, the control mode determination section 20 is configured to determine execution of one of the PWM control mode and the rectangular-wave control mode. However, the present invention is not limited thereto. An X-pulse control mode (for example, a three-pulse control mode, a five-pulse control mod; or the like) in which the switching elements are turned on and off X (X is an integer of 2 or more) times each per one cycle of the electrical angle of the electric motor MG may be provided as a control mode selectable by the control mode determination selection 20. The X-pulse control mode is a rotation synchronization control mode, as with the rectangular-wave control mode. In a configuration in which the control mode determination section can determine execution of the X-pulse control mode, the computation cycles of the respective functional sections (respective processes) may be set during execution of the X-pulse control mode in the same way as during execution of the rectangular-wave control mode in the above embodiments.

(12) In the above first and second embodiments, the electric motor drive device 2 supplies the inverter 6 with the DC voltage Vde from the DC power source 3. However, the present invention is not limited thereto. For example, in one suitable embodiment of the present invention, a voltage conversion section, such as a DC/DC converter, that converts a power source voltage from the DC power source 3 to generate a desired system voltage may be provided, and the system voltage generated by the voltage conversion section may be supplied to the inverter 6 serving as a DC/AC conversion section. In this case, the voltage conversion section may be a voltage boost converter that boosts the power source voltage, a voltage reducing converter that reduces the power source voltage, or a voltage boost/reducing converter that both boosts and reduces the power source voltage.

(13) In the above first and second embodiments, the electric motor MG is an interior permanent magnet synchronous motor (IPMSM) that operates on three-phase AC. However, the present invention is not limited thereto. For example, the electric motor MG may be a surface permanent magnet synchronous motor (SPMSM), or may be an induction motor or the like, for example, rather than a synchronous motor. The AC to be supplied to such an electric motor MG may be single-phase, two-phase, and other multi-phase AC with four or more phases, rather than three-phase AC.

(14) In the above first and second embodiments, the respective functional sections of the control device I are formed by the electric motor control program (that is, software) stored in the memory (program memory) of the CPU 1a. However, at least some of the functional sections of the control device 1 may be formed to include hardware.

(15) Also regarding other configurations, the embodiments disclosed herein are illustrative in all respects, and the present invention is not limited thereto. That is, it is a matter of course that a configuration obtained by appropriately altering part of a configuration not disclosed in the claims of the present invention also falls within the technical scope of the present invention as long as the resulting configuration includes a configuration disclosed in the claims or a configuration equivalent thereto.

The present invention is suitably applicable to a control device that controls an electric motor drive device including a DC/AC conversion section that converts a DC voltage into an AC voltage to supply the AC voltage to an AC electric motor.

What is claimed is:

1. A control device that controls an electric motor drive device including a DC/AC conversion section that converts a DC voltage into an AC voltage to supply the AC voltage to an AC electric motor, comprising:
a control mode determination section that determines execution of one of a plurality of control modes including a pulse width modulation control mode and a rectangular-wave control mode;
a voltage command value determination section that determines an AC waveform command value, which is a command value of a waveform of the AC voltage supplied from the DC/AC conversion section to the AC electric motor, as a voltage command value in the case where the control mode determined by the control mode determination section is the pulse width modulation control mode, and that determines a phase value of a rectangular-wave voltage as the voltage command value in the case where the control mode determined by the control mode determination section is the rectangular-wave control mode;
a control signal generation section that generates a control signal for the DC/AC conversion section on the basis of the control mode determined by the control mode determination section and the voltage command value; and
a computation cycle setting section that sets a computation cycle of the control signal generation section to a first cycle, which is N times (N is an integer of 1 or more) a reference computation cycle that is set to half a carrier cycle, and that sets a computation cycle of the voltage command value determination section to a second cycle, which is M times (M is an integer of 2 or more) the first cycle, in the case where the control mode determined by the control mode determination section is the pulse width modulation control mode, wherein
the computation cycle setting section sets both the computation cycle of the voltage command value determination section and the computation cycle of the control signal generation section to the second cycle in the case where the control mode determined by the control mode determination section is the rectangular-wave control mode.

2. The control device according to claim 1, further comprising:
a torque deviation derivation section that derives a deviation between an output torque and a target torque of the AC electric motor, wherein
the voltage command value determination section performs at least proportional control and integral control on the basis of the deviation derived by the torque deviation derivation section to determine the phase value of the rectangular-wave voltage in the case where the control mode determined by the control mode determination section is the rectangular-wave control mode, and
the computation cycle setting section sets a computation cycle of the torque deviation derivation section to a third cycle, which is L times (L is an integer of 2 or more) the second cycle, in the case where the control mode determined by the control mode determination section is the rectangular-wave control mode.

3. The control device according to claim 2, further comprising:
an estimated torque value derivation section that derives an estimated torque value, which is an estimated value of the output torque, on the basis of a detected value of a current flowing through a coil of the AC electric motor, wherein
the torque deviation derivation section derives the deviation using the estimated torque value as the output torque, and
the computation cycle setting section sets a computation cycle of the estimated torque value derivation section to the third cycle in the case where the control mode determined by the control mode determination section is the rectangular-wave control mode.

4. The control device according to claim 1, wherein
computation processes for determining the voltage command value through the voltage command value determination sections for the AC electric motors in the number M are performed by a single computation processing unit, and
computations through the voltage command value determination sections for the respective M AC electric motors are performed in the second cycles and in the reference computation cycles that are different from each other.

5. The control device according to claim 2, wherein
computation processes for determining the voltage command value through the voltage command value determination sections for the AC electric motors in the number M are performed by a single computation processing unit, and
computations through the voltage command value determination sections for the respective M AC electric motors are performed in the second cycles and in the reference computation cycles that are different from each other.

6. The control device according to claim 2, wherein
computation processes for determining the voltage command value through the voltage command value determination sections for the AC electric motors in the number M are performed by a single computation processing unit, and
computations through the voltage command value determination sections for the respective MAC electric motors are performed in the second cycles and in the reference computation cycles that are different from each other.
